(19) United States
(12) Patent Application Publication
(10) Pub. No.: US 2026/0249321 A1
(43) Pub. Date: Aug. 27, 2026

(54) FASTENING ASSEMBLY AND ELECTRO-DEPOSITION COATING METHOD OF VEHICLE STRUCTURE

(71) Applicant: Honda Motor Co., Ltd., Tokyo (JP)

(72) Inventors: Ryuichi HIGASHI, Tokyo (JP); Kuniyuki HISHINUMA, Tokyo (JP)

(73) Assignee: Honda Motor Co., Ltd., Tokyo (JP)

(21) Appl. No.: 19/369,379

(22) Filed: Oct. 27, 2025

(30) Foreign Application Priority Data
Feb. 25, 2025 (CN) 202510208350.5

(51) Int. Cl. B05D 1/00; B05D 3/00; F16B 35/00; F16B 37/00

(52) U.S. Cl. CPC B05D 1/007; B05D 3/002; F16B 35/00; F16B 37/00; F16B 2200/79

(57) ABSTRACT

The fastening assembly includes a first fastener and a second fastener, the first fastener and the second fastener respectively have mating surfaces that enable the first fastener and the second fastener to match each other, a water-soluble coating layer is coated on the mating surface of at least one of the first fastener and the second fastener, and a coating material of the water-soluble coating layer contains a polyvinyl alcohol-based polymer to which a lubricant is added.

### CROSS-REFERENCE TO RELATED APPLICATION

This application claims the priority benefit of China application serial no. 202510208350.5, filed on Feb. 25, 2025. The entirety of the above-mentioned patent application is hereby incorporated by reference herein and made a part of this specification.

### BACKGROUND

### Technical Field

The disclosure relates to a fastening assembly and an electro-deposition coating method of vehicle structure.

### Description of Related Art

In recent years, research and development contributing to energy efficiency are being conducted in order to ensure access to more affordable, reliable, sustainable and advanced energy for more people.

Generally, in order to protect vehicles from corrosion, an electro-deposition coating process is usually adopted in the vehicle manufacturing process to perform anti-rust treatment on vehicle surfaces. Specifically, the electro-deposition coating process includes an electrophoretic deposition step and a baking step. In the electrophoretic deposition step, charged electro-deposition coating material particles are dispersed in water, and when electricity is applied, the charged electro-deposition coating material particles move toward the electrode with opposite polarity under the action of an electric field and deposit on the vehicle surface, forming a uniform water-insoluble coating film. Subsequently, a baking step is performed to cure the coating film, thereby enabling the vehicle to achieve anti-corrosion performance.

However, in the conventional art, before performing the electro-deposition coating process, it is necessary to first fix external panels including members such as engine hoods, doors, fenders, and rear panels to the vehicle body frame using fasteners such as bolts and nuts to form a vehicle structure, and then immerse the vehicle structure in an electro-deposition coating material tank to perform the electrophoretic deposition step. Generally, existing bolts and nuts are mostly made of steel and have a high friction coefficient, making them difficult to slide. As such, wear often forms on the mating surfaces of the bolts and nuts, or the fasteners and the fastened objects rotate together. Although Patent Document 1 (Japanese Patent Laid-Open No. H02-134407) in the conventional art literature provides a nut coated with polytetrafluoroethylene (PTFE) resin to reduce the friction coefficient and prevent wear or co-rotation, the lubricating coating material used to reduce the friction coefficient in Patent Document 1 of the conventional art literature has a repelling effect on the electro-deposition coating material. Thus, the anti-rust treatment of bolts, nuts and their connection parts need to rely on the lubricating coating material to complete, but this also causes waste of the electro-deposition coating material. Thus, there is a need for a fastener with lubricity performance to prevent co-rotation of external panels and fasteners during the assembly process, and which may not affect the progress of the electro-deposition coating process serving as anti-rust treatment, so as to reliably perform electro-deposition coating on the vehicle structure.

The present application achieves reliable electro-deposition coating on vehicle structure. Moreover, it further contributes to energy efficiency.

The disclosure provides a fastening assembly and an electro-deposition coating method of a vehicle structure, in which the fastening assembly has good lubricity performance and enables the electro-deposition coating method of the vehicle structure to be reliably performed.

### SUMMARY

According to an embodiment of the disclosure, the fastening assembly includes a first fastener and a second fastener, in which the first fastener and the second fastener respectively have mating surfaces that enable the first fastener and the second fastener to match each other, a water-soluble coating layer is coated on the mating surface of at least one of the first fastener and the second fastener, and a coating material of the water-soluble coating layer contains a polyvinyl alcohol-based (PVA) polymer to which a lubricant is added.

According to an embodiment of the disclosure, an electro-deposition coating method of a vehicle structure includes: utilizing the fastening assembly to fix an external panel to a vehicle body to form a vehicle structure; cleaning the vehicle structure, and simultaneously removing the water-soluble coating layer on the fastening assembly; and performing electro-deposition coating on the vehicle structure.

Based on the above, in the embodiment of the disclosure, by coating a water-soluble coating layer on the mating surface of at least one of the first fastener and the second fastener of the fastening assembly, and through the coating material of the water-soluble coating layer containing a polyvinyl alcohol-based polymer component to which a lubricant is added, the friction coefficient of the mating surfaces in the fastening assembly may be reduced through the lubricant added in the polyvinyl alcohol-based polymer, thereby preventing the fastening assembly and the member it fastens from rotating together due to rotational torque during tightening. Furthermore, since the polyvinyl alcohol-based polymer is easily soluble in water, when the coating layer of the fastening assembly is no longer needed, it may be easily peeled off and removed with water. Thereby, the fastening assembly may be used in the electro-deposition coating method of vehicle structure of the embodiment of the disclosure and may prevent the condition that the external panel and the fastening assembly rotate together during the assembly process of the vehicle structure, and the water-soluble coating layer of the fastening assembly may be removed through performing the cleaning step before the electro-deposition coating step. In this way, the fastening assembly does not affect the performance of the electro-deposition coating step serving as rust prevention treatment, and thus enables reliable electro-deposition coating of the vehicle structure.

In order to make the aforementioned features and advantages of the disclosure comprehensible, embodiments accompanied with drawings are described in detail below.

### BRIEF DESCRIPTION OF THE DRAWINGS

FIG. 1 is a schematic diagram of a fastening assembly according to an embodiment of the disclosure;

FIG. 2 is a cross-sectional schematic diagram of the electro-deposition coating method of the vehicle structure shown in FIG. 1.

### DESCRIPTION OF THE EMBODIMENTS

In an embodiment of the disclosure, the first fastener and the second fastener are respectively a bolt and a nut, and the mating surface of the first fastener and the mating surface of the second fastener are threaded mating surfaces.

In an embodiment of the disclosure, the lubricant is a solid lubricant.

In an embodiment of the disclosure, the solid lubricant is graphite.

In an embodiment of the disclosure, in mass percentage, in the water-soluble coating layer, a content of the graphite serving as the solid lubricant is 0.3% to 5.0%.

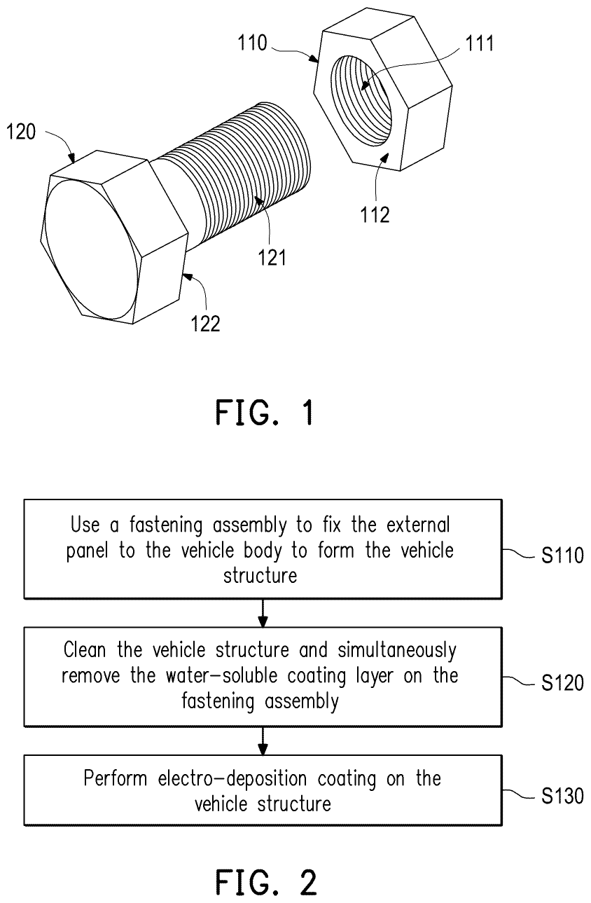

Reference will now be made in detail to the exemplary embodiments of the disclosure, and examples of the exemplary embodiments are illustrated in the accompanying drawings. Whenever possible, the same reference numerals are used in the drawings and the description to indicate the same or similar parts. FIG. 1 is a schematic diagram of a fastening assembly according to an embodiment of the disclosure; FIG. 2 is a cross-sectional schematic diagram of the electro-deposition coating method of the vehicle structure shown in FIG. 1.

Referring to FIG. 1, in this embodiment, the fastening assembly 100 includes a first fastener 110 and a second fastener 120, the first fastener 110 and the second fastener 120 respectively have mating surfaces S1 and S2 that enable the first fastener 110 and the second fastener 120 to match each other, a water-soluble coating layer is coated on the mating surfaces S1 and S2 of at least one of the first fastener 110 and the second fastener 120, and the coating material of the water-soluble coating layer contains a polyvinyl alcohol-based polymer to which a lubricant is added. For example, as shown in FIG. 1, in this embodiment, the first fastener 110 and the second fastener 120 are respectively a bolt and a nut, and the mating surface S1 of the first fastener 110 and the mating surface S2 of the second fastener 120 are threaded mating surfaces.

Thus, by coating a water-soluble coating layer on the mating surfaces S1 and S2 of at least one of the first fastener 110 and the second fastener 120 of the fastening assembly 100, and through the coating material of the water-soluble coating layer containing a polyvinyl alcohol-based polymer component to which a lubricant is added, the friction coefficient of the mating surfaces S1 and S2 in the fastening assembly 100 may be reduced through the lubricant added in the polyvinyl alcohol-based polymer, thereby preventing the fastening assembly 100 and the member it fastens from rotating together due to rotational torque during tightening. Specifically, the friction coefficient of the mating surfaces S1 and S2 in the fastening assembly 100 may be evaluated through an index called torque coefficient, this index is calculated according to the fastening torque, axial force and nominal diameter of the fastener, when other conditions remain unchanged and when the friction coefficient is lower, its torque coefficient is also smaller. For example, in this embodiment, through the configuration of the water-soluble coating layer, the torque coefficient of the mating surfaces S1 and S2 in the fastening assembly 100 may be reduced to 0.2 or lower, while the torque coefficient of bolts in the conventional art that are not coated with a water-soluble coating layer is approximately 0.4. Thus, through the reduction of the friction coefficient of the mating surfaces S1 and S2 in the fastening assembly 100, the axial force of the bolt is easily obtained, and higher fastening strength may be achieved with smaller fastening torque.

For example, in this embodiment, the lubricant may be a solid lubricant. Since the function of the water-soluble coating layer is to reduce the friction coefficient of the fastening assembly 100, solid lubricants with low friction coefficients are preferentially used as lubricants. The following will use materials such as graphite, talc, polytetrafluoroethylene (PTFE) as solid lubricants, and by mass percentage, in the water-soluble coating layer, the content of solid lubricants is all 5.0%, and their lubricity performance is confirmed by sampling test method, and the test results are listed in Table 1 as follows, where ∘ in Table 1 indicates that its torque coefficient is lower than 0.2 and has good lubricity performance, while x indicates that the torque coefficient is not lower than 0.2.

TABLE 1

| Sample No. | Graphite | Talc | Alumina | Polytetrafluoroethylene |
|---|---|---|---|---|
| 1 | ◯ | ◯ | X | ◯ |
| 2 | ◯ | X | X | ◯ |
| 3 | ◯ | ◯ | X | ◯ |
| 4 | ◯ | X | X | ◯ |
| 5 | ◯ | ◯ | X | ◯ |

From Table 1 above, it may be known that using materials such as graphite, talc, polytetrafluoroethylene as solid lubricants may effectively reduce the friction coefficient. Thus, in this embodiment, materials such as graphite, talc, polytetrafluoroethylene may be used as solid lubricants, but the disclosure is not limited thereto, in other embodiments, the solid lubricant may also consider selecting other solid lubricants having lubricity performance, such as compounds like molybdenum disulfide.

Moreover, since the test results of Table 1 show that although materials such as graphite, talc, polytetrafluoroethylene all have good lubricity, since the performance of talc is relatively unstable in data, and polytetrafluoroethylene will appear obvious bubbles in the water-soluble coating layer, in this embodiment, it is preferable to use graphite as the solid lubricant. The following will further perform adjustment tests for the addition amount of graphite as the solid lubricant, and the test results are listed in Table 2 as follows, where the meanings of ∘ and x in Table 2 are the same as those in Table 1.

TABLE 2

| Sample | Graphite addition ratio | | | | |
|---|---|---|---|---|---|
| No. | 5% | 3% | 1% | 0.5% | 0.3% |
| 1 | ◯ | ◯ | ◯ | ◯ | ◯ |
| 2 | ◯ | ◯ | ◯ | ◯ | ◯ |
| 3 | ◯ | ◯ | ◯ | ◯ | ◯ |
| 4 | ◯ | ◯ | ◯ | ◯ | ◯ |
| 5 | ◯ | ◯ | ◯ | ◯ | ◯ |

From Table 2 above, it may be known that in this embodiment, by mass percentage, in the water-soluble coating layer, when the content of the graphite serving as the solid lubricant is 0.3% to 5.0%, good lubricity performance may all be achieved. Moreover, since polyvinyl alcohol-based polymer is easily soluble in water, adding graphite in a mass percentage range of 0.3% to 5.0% in the water-soluble coating layer may still simultaneously enable the mating surfaces S1 and S2 in the fastening assembly 100 to obtain good lubricity and enable the water-soluble coating layer to maintain good water solubility. Thus, when the water-soluble coating layer of the fastening assembly 100 is no longer needed, it may be easily peeled off and removed with water. Thereby, the fastening assembly 100 may be used in the electro-deposition coating method of vehicle structure of the embodiment of the disclosure and may prevent the condition that the external panel and the fastening assembly 100 rotate together during the assembly process of the vehicle structure, and the water-soluble coating layer of the fastening assembly 100 may be removed through performing the cleaning step before the electro-deposition coating step. The following will further illustrate the electro-deposition coating method of vehicle structure with reference to FIG. 2.

As shown in FIG. 2, in this embodiment, the electro-deposition coating method of vehicle structure includes assembly step S110, cleaning step S120, and electro-deposition coating step S130. Specifically, in assembly step S110, the fastening assembly 100 may be used to fix the external panel to the vehicle body to form the vehicle structure. For example, in this embodiment, the external panel includes members serving as vehicle surfaces such as engine hood, doors, fenders, rear panels, and the vehicle body is the frame member of the vehicle body. Thus, when the external panel is assembled with the vehicle body through the fastening assembly 100, since the water-soluble coating layer of the fastening assembly 100 has good lubricity performance and has a low friction coefficient, it may prevent the external panel from rotating together due to the rotational torque when being fastened through the fastening assembly 100, thereby may prevent the external panel from rotating and displacing relative to the vehicle body, and may reliably perform assembly.

Next, in cleaning step S120, the vehicle structure is cleaned with water to remove impurities adhered to the surface of the vehicle structure (such as iron powder or residues of rust-preventive oil coated on the steel plate surface to prevent rusting when the iron plate contacts air for oxidation, grease, oxides and other impurities, etc.) and simultaneously remove the water-soluble coating layer on the fastening assembly 100. Next, in electro-deposition coating step S130, electro-deposition coating is performed on the vehicle structure. Thus, since the impurities adhered to the surface of the vehicle structure and the water-soluble coating layer of the fastening assembly 100 have all been removed, the coating particles of electro-deposition coating material may be uniformly deposited on each surface portion of the vehicle structure (including the fastening assembly 100 with the water-soluble coating layer removed and surface portions near it), and may form a uniform coating layer with strong adhesion, thereby may ensure the quality, durability and protective performance (anti-corrosion performance) of the coating layer formed in electro-deposition coating step S130.

Compared with the water-soluble coating layer on the fastening assembly 100 of this embodiment, the difficult-to-clean coating layer used for fastening assemblies in the prior art may not be removed through cleaning step S120, thus it may affect the quality of the coating layer formed in electro-deposition coating step S130, and may not ensure the quality, durability and protective performance (anti-corrosion performance) of the coating layer formed in electro-deposition coating step S130 of the electro-deposition coating method of vehicle structure.

In summary, in the embodiment of the disclosure, by coating a water-soluble coating layer on the mating surface of at least one of the first fastener and the second fastener of the fastening assembly, and through the coating material of the water-soluble coating layer containing a polyvinyl alcohol-based polymer component to which a lubricant is added, the friction coefficient of the mating surfaces in the fastening assembly may be reduced through the lubricant added in the polyvinyl alcohol-based polymer, thereby preventing the fastening assembly and the member it fastens from rotating together due to rotational torque during tightening. Furthermore, since the polyvinyl alcohol-based polymer is easily soluble in water, when the water-soluble coating layer of the fastening assembly is no longer needed, it may be easily peeled off and removed with water. Thereby, the fastening assembly may be used in the electro-deposition coating method of vehicle structure of the embodiment of the disclosure and may prevent the condition that the external panel and the fastening assembly rotate together during the assembly process of the vehicle structure, and the water-soluble coating layer of the fastening assembly may be removed through performing the cleaning step before the electro-deposition coating step. In this way, the fastening assembly does not affect the performance of the electro-deposition coating step serving as rust prevention treatment, and thus enables reliable electro-deposition coating of the vehicle structure.

Finally, it should be noted that the above embodiments are only used to illustrate the technical solutions of the disclosure and are not intended to limit it. Although the disclosure has been described in detail with reference to the above embodiments, persons of ordinary skill in the art should understand that they may still modify the technical solutions described in the above embodiments, or replace some or all of the technical features therein with equivalents, and that such modifications or replacements of corresponding technical solutions do not substantially deviate from the scope of the technical solutions of the embodiments of the disclosure.

What is claimed is:

1. A fastening assembly, comprising:
a first fastener and a second fastener, wherein the first fastener and the second fastener respectively have mating surfaces that enable the first fastener and the second fastener to match each other, a water-soluble coating layer is coated on the mating surface of at least one of the first fastener and the second fastener, and a coating material of the water-soluble coating layer contains a polyvinyl alcohol-based polymer to which a lubricant is added.

2. The fastening assembly according to claim 1, wherein the first fastener and the second fastener are respectively a bolt and a nut, and the mating surface of the first fastener and the mating surface of the second fastener are threaded mating surfaces.

3. The fastening assembly according to claim 1, wherein the lubricant is a solid lubricant.

4. The fastening assembly according to claim 3, wherein the solid lubricant is graphite.

5. The fastening assembly according to claim 4, wherein in mass percentage, in the water-soluble coating layer, a content of the graphite serving as the solid lubricant is 0.3% to 5.0%.

6. An electro-deposition coating method of a vehicle structure, comprising:
utilizing the fastening assembly according to claim 1 to fix an external panel to a vehicle body to form a vehicle structure;
cleaning the vehicle structure, and simultaneously removing the water-soluble coating layer on the fastening assembly; and
performing electro-deposition coating on the vehicle structure.

7. An electro-deposition coating method of a vehicle structure, comprising:
utilizing the fastening assembly according to claim 2 to fix an external panel to a vehicle body to form a vehicle structure;
cleaning the vehicle structure, and simultaneously removing the water-soluble coating layer on the fastening assembly; and
performing electro-deposition coating on the vehicle structure.

8. An electro-deposition coating method of a vehicle structure, comprising:
utilizing the fastening assembly according to claim 3 to fix an external panel to a vehicle body to form a vehicle structure;
cleaning the vehicle structure, and simultaneously removing the water-soluble coating layer on the fastening assembly; and
performing electro-deposition coating on the vehicle structure.

9. An electro-deposition coating method of a vehicle structure, comprising:
utilizing the fastening assembly according to claim 4 to fix an external panel to a vehicle body to form a vehicle structure;
cleaning the vehicle structure, and simultaneously removing the water-soluble coating layer on the fastening assembly; and
performing electro-deposition coating on the vehicle structure.

10. An electro-deposition coating method of a vehicle structure, comprising:
utilizing the fastening assembly according to claim 5 to fix an external panel to a vehicle body to form a vehicle structure;
cleaning the vehicle structure, and simultaneously removing the water-soluble coating layer on the fastening assembly; and
performing electro-deposition coating on the vehicle structure.
